(19) United States
(12) Patent Application Publication
(10) Pub. No.: US 2024/0258089 A1
(43) Pub. Date: Aug. 1, 2024

(54) Electron Multiplier Having Improved Voltage Stabilisation

(71) Applicant: Adaptas Solutions Pty Ltd, Clyde, New South Wales (AU)

(72) Inventors: Daen Ekers, Clyde (AU); David Whiteley, Clyde (AU)

(21) Appl. No.: 18/564,743

(22) PCT Filed: May 26, 2022
(86) PCT No.: PCT/AU2022/050505

§ 371 Date: Nov. 28, 2023

(30) Foreign Application Priority Data
May 31, 2021 (AU) 2021901618

(51) Int. Cl. H01J 43/30; H01J 43/18

(52) U.S. Cl. CPC H01J 43/30; H01J 43/18

(57) ABSTRACT

The present invention relates to electron multipliers as used in ion detection apparatus such as mass spectrometers. The multiplier comprises a voltage stabilizing component or system, and is configured to reduce a negative effect of voltage fluctuations within and/or electromagnetic radiation emitted by the voltage stabilizing component or system during operation on an output signal of the electron multiplier. The multiplier may be configured so as to decouple the voltage fluctuations within and/or the electromagnetic radiation emitted by the voltage stabilizing component or system from its output signal.

### FIELD OF THE INVENTION

The present invention relates generally to components of scientific analytical equipment, and also to complete items of analytic equipment. More particularly, but not exclusively the present invention relates to electron multipliers as used in ion detection apparatus such as mass spectrometers.

### BACKGROUND TO THE INVENTION

In basic terms, an electron multiplier functions to amplify an input signal. The input may be very low, such as a single ion output by a mass spectrometer's analyser. In order to provide a high level of sensitivity an electron multiplier must be constructed and operated to provide the high gains required to derive a useful output signal.

Electron multipliers generally operate by way of secondary electron emission whereby the impact of a single or multiple particles on the multiplier impact surface causes single or (preferably) multiple electrons associated with atoms of the impact surface to be released. The output from one secondary electron emission forms the input of another secondary electron emission, such that the electron signal increases exponentially across a number of electron emission steps. A collector electrode (typically an anode) is provided to collect the electrons that are emitted by the terminal electron emissive surface. The collected electrons are conducted away from the collector by a wire, and form the multiplier output. The multiplier output typically forms the input of a software-based analyser.

One type of electron multiplier is known as a discrete-dynode electron multiplier. Such multipliers include a series of surfaces called dynodes, with each dynode in the series set to increasingly more positive voltage. Each dynode is capable of emitting one or more electrons upon impact from secondary electrons emitted from previous dynodes, thereby amplifying the input signal. A typical discrete-dynode electron multiplier has between 12 and 24 dynode stages, and is used at an operating gain of between 10⁴ and 10⁸, depending on the application. In GC-MS applications, for example, the electron multiplier is typically operated in analog mode with a gain of around 10⁵. For a new electron multiplier this gain is typically achieved with an applied high voltage of ˜1400 volts.

Other types of multiplier are known in the art in which electron amplification occurs over a continuous dynode. A continuous dynode system typically uses a horn-shaped funnel structure. The inner surface is coated or treated to achieve secondary emission. Continuous dynodes use an increasingly positive voltage from the input to the output end. The first device of this kind was called a Channel Electron Multiplier (CEM). CEMs typically require 2-4 kilovolts in order to achieve a gain of 10⁶ electrons.

Another type of continuous-dynode electron multiplier is called a microchannel plate (MCP). It may be considered a 2-dimensional parallel array of very small continuous-dynode electron multipliers, constructed together and powered in parallel. Each microchannel is generally parallel-walled. MCPs typically carry a resistance of around 10⁹Ω between each electrode. The electron gain for one microchannel plate may be around 10⁴-10⁷ electrons.

Irrespective of type, a fundamental characteristic of an electron multiplier is its linearity. Linearity is a measure of the ratio of the actual detector output to the expected detector output. Linearity is typically measured as a function of the actual, measured output. The known linearity can be used to correct the actual output to obtain the attempted output of the multiplier. For example, at a linearity of 1 and 0.5 at a measured output of 100 μA means that the detector is trying to output 100 μA and 200 μA, respectively.

Any departure from a linear response is of course undesirable. A common cause of non-linearity is voltage collapse, whereby the electron cascade generated inside an electron multiplier becomes significant in size relative to the strip current of the multiplier. The strip current is the current that flows through the electron multiplier physical circuit. The electron cascade is a virtual circuit that runs in parallel to the electron multiplier physical circuit. The electron cascade can be considered to pull current from the physical circuit, and directing it into this parallel virtual circuit. This has the side effect of reducing the strip current along each of these parallel sections.

The reduction in strip current then causes voltage losses across these parallel sections. As the electron cascade grows larger with every amplification step, the voltage losses increase towards the electron multiplier collector (typically an anode). These voltage losses are often referred to as ‘voltage collapse’.

The total voltage applied to the electron multiplier does not decrease as a result of voltage collapse. Instead the ‘missing’ voltage shunts to the input of the electron multiplier. The end result of voltage collapse is therefore a re-distribution of voltage along the entire electron multiplier. Voltage between the electron multiplier amplification sites is increased at the input, about the same in the middle and reduced near the collector. The electron amplification of a multiplier emissive surfaces is highly dependent upon these voltages, and therefore the gain of the electron multiplier is altered. As voltage collapse is driven by the magnitude of the electron cascade relative to the strip current, an output current dependent gain results. Thus voltage collapse determines the linearity of an electron multiplier.

Various means have been used to prevent voltage collapse, and therefore improve electron multiplier linearity. As an example, Zener diodes have been used to “lock” the voltage difference between two points in the electron amplification chain. The cost of adding a Zener diode is a reduction in electron multiplier operating life. For this reason, only one or two Zener diodes are typically added to the end region of an electron multiplier.

Applicant proposes for the first time the use of improved voltage stabilizing means to address the issue of voltage collapse and the attendant negative effect on linearity in electron multipliers. While having greater effect than the one or two Zener diodes used in the prior art, the improved voltage stabilisation means was found to cause a degradation in electron multiplier output. Specifically an increase in noise was noted empirically, which will reduce the signal to noise (S/N) ratio of the electron multiplier, and in turn lead to a reduction in multiplier sensitivity. Thus, in improving multiplier linearity, noise and sensitivity are compromised.

It is an aspect of the present invention to provide an improvement to prior art electron multiplier to provide a multiplier having improved linearity while maintaining an acceptable sensitivity. It is a further aspect of the present invention to provide a useful alternative to prior art electron multipliers.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, but not necessarily the broadest aspect, the present invention provides an electron multiplier comprising a voltage stabilizing component or system, the electron multiplier configured so as to reduce a negative effect of voltage fluctuations within and/or electromagnetic radiation emitted by the voltage stabilizing component or system during operation on an output signal of the electron multiplier.

In one embodiment of the first aspect, the electron multiplier is configured so as to provide an output signal, and further configured so as to decouple the voltage fluctuations within and/or electromagnetic radiation emitted by the voltage stabilizing component or system from the output signal.

In one embodiment of the first aspect, the electron multiplier comprises an electron emissive surface and an electron collector configured to collect electrons from the electron emissive surface, wherein the electron multiplier is configured to reduce exposure of a dynode (where present) and/or the electron collector and/or a conductive element carrying electrons away from the electron collector to the voltage fluctuations within and/or electromagnetic radiation emitted by the voltage stabilizing component or system.

In one embodiment of the first aspect, the electron multiplier comprises means for directing voltage fluctuations within and/or electromagnetic radiation emitted by the voltage stabilizing component or system away from a dynode (where present) and/or the electron collector and/or a conductive element carrying electrons away from the electron collector.

In one embodiment of the first aspect, the means for directing voltage fluctuations is configured to direct the voltage fluctuations to an electrical ground.

In one embodiment of the first aspect, the means for directing voltage fluctuations is a frequency-specific filter configured to direct a portion of, most of, or substantially all of the voltage fluctuations arising in the voltage stabilizing component or system away from a dynode (where present) and/or the electron collector and/or a conductive element carrying electrons away from the electron collector.

In one embodiment of the first aspect, the filter is configured to operate preferentially on voltage fluctuations at frequencies of the voltage fluctuations arising in the voltage stabilizing component or system.

In one embodiment of the first aspect, a portion of, most of, or substantially all the frequencies are higher than frequencies of electromagnetic radiation emitted by a strip current conductor of the electron multiplier

In one embodiment of the first aspect, the filter is configured to filter electromagnetic radiation in the frequency band of 0.1 GHz to 1000 GHz.

In one embodiment of the first aspect, the filter is a multipole filter connected to the voltage stabilizing component or system.

In one embodiment of the first aspect, the electron multiplier comprises an electromagnetic radiation interceptor configured and positioned to reduce the amount of electromagnetic radiation emitted by the voltage stabilizing component or system to which a dynode (where present) and/or the electron collector and/or a conductive element carrying electrons away from the electron collector is/are exposed.

In one embodiment of the first aspect, the electromagnetic radiation interceptor is configured to functions so as to absorb and/or reflect and/or deflect, and/or divert and/or bend and/or cancel and/or diffract and/or refract and/or dissipate electromagnetic radiation emitted by the voltage stabilizing component or system.

In one embodiment of the first aspect, the electromagnetic radiation interceptor is fabricated from an electrically conductive and/or a magnetic material.

In one embodiment of the first aspect, the electromagnetic radiation interceptor is continuous or discontinuous, including a mesh.

In one embodiment of the first aspect, the electromagnetic radiation interceptor is configured to absorb and/or reflect and/or deflect, and/or divert and/or bend and/or cancel and/or diffract and/or refract and/or dissipate some, most, or substantially all of the electromagnetic radiation emitted by the voltage stabilizing component or system.

In one embodiment of the first aspect, the electromagnetic radiation interceptor is a radio frequency (RF) shield.

In one embodiment of the first aspect, the electromagnetic radiation interceptor or part thereof is physically disposed along a line of sight between the voltage stabilizing component or system and a dynode (where present) and/or the electron collector and/or a conductive element carrying electrons away from the electron collector.

In one embodiment of the first aspect, the electromagnetic radiation interceptor partially or substantially completely surrounds the one or more voltage stabilizing component or system.

In one embodiment of the first aspect, the electromagnetic radiation interceptor contacts or is adjacent to a structure of the electron multiplier.

In one embodiment of the first aspect, the structure is a board of the electron multiplier.

In one embodiment of the first aspect, the board provides a substrate for one or more electrical or electronic components of the electron multiplier.

In one embodiment of the first aspect, the electromagnetic radiation interceptor is configured to absorb and/or reflect and/or diffract and/or refract electromagnetic radiation in the frequency band of 0.1 GHz to 1000 GHz.

In one embodiment of the first aspect, the voltage stabilizing component or system is a current limiting component or system.

In one embodiment of the first aspect, the current limiting component or system is or comprises a diode.

In one embodiment of the first aspect, the diode is a voltage sensitive diode.

In one embodiment of the first aspect, the voltage stabilizing component is a Zener diode, an avalanche diode or a functional equivalent thereof.

In one embodiment of the first aspect, the voltage stabilizing system comprises at least one Zener diode, avalanche diode or a functional equivalent thereof.

In one embodiment of the first aspect, the voltage stabilizing system comprises at least 1, 2, 3, 4 or 5 Zener diodes or avalanche dynodes, or functional equivalents thereof.

In one embodiment of the first aspect, the electromagnetic radiation emitted by the voltage stabilizing component or system is flicker noise or pink noise

In a second aspect, the present invention provides a scientific instrument having installed therein the electron multiplier of any embodiment of the first aspect.

### BRIEF DESCRIPTION OF THE FIGURES

FIG. 1 illustrates a circuit diagram of a prior art discrete dynode electron multiplier devoid of any means for reducing voltage collapse.

FIG. 2 illustrates a circuit diagram of the prior art multiplier of FIG. 1, although having 3 Zener diodes connected in series to reduce voltage collapse and increase linearity of response.

FIG. 3 illustrates a circuit diagram of the prior art multiplier of FIG. 1, although having 3 Zener diodes connected in parallel to reduce voltage collapse and increase linearity of response.

FIG. 4 illustrates a circuit diagram of electron multiplier of FIG. 2, although including capacitors configured to filter voltage fluctuations.

FIG. 5 illustrates a circuit diagram of an electron multiplier of FIG. 3, although including capacitors configured to filter voltage fluctuations.

FIG. 6 illustrates diagrammatically the gross physical features of a discrete dynode electron multiplier of the prior art.

FIG. 7 illustrates diagrammatically, the gross physical features of a preferred electron multiplier of the present invention having a first, second and third board, and a RF shield disposed between the first and third boards.

Unless otherwise indicated herein, features of the drawings labelled with the same numeral are taken to be the same features, or at least functionally similar features, when used across different drawings.

The drawings are not prepared to any particular scale or dimension and are not presented as being a completely accurate presentation of the various embodiments.

### DETAILED DESCRIPTION OF THE INVENTION AND PREFERRED EMBODIMENTS THEREOF

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments, or indeed any embodiment covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

The present invention is predicated at least in part on the inventors' finding that in improving multiplier linearity, noise levels were increased. Moreover, the increase in noise could be addressed to some extent at least by reducing the exposure of the electron multiplier collector and/or a dynode to an amount of voltage fluctuation arising within and/or electromagnetic radiation emitted by voltage stabilisation means. Applicant has further found that an electron multiplier having a shortened service life nevertheless has utility to some end users given some aspects of multiplier usage.

More particularly it has been found that where an improved means for inhibiting voltage collapse is incorporated into an electron multiplier, the degradation in electron multiplier output arises due to the electromagnetic radiation emitted from and/or voltage fluctuations arising within the means for inhibiting voltage collapse, often in the form of flicker noise, or pink noise: i.e. noise with a 1/f power spectral density. In light of the inverse relationship, the contribution of the voltage fluctuations to the elevated noise is of greater magnitude at lower frequencies.

Yet more particularly, the inventors have discovered that an increase in electron multiplier linearity may be usefully provided by the use of three of more Zener diodes connected across terminal dynodes or a terminal dynode region, so long as the unexpectedly significant levels of noise from the diodes and the attendant impact on the collector and dynodes is addressed.

Without wishing to be limited by theory in any way, it is proposed that the problematic noise may arise from electrons at the Zener diodes P-N junction randomly transitioning from one side of the junction to the other. This creates a charge imbalance which is observed as a voltage fluctuation. This voltage fluctuation propagates along the circuit and creates noise in the output signal. At the same time, this voltage fluctuation drives electrons back across the P-N junction, the back and forth motion emitting electromagnetic radiation, much like an antenna. When this electromagnetic radiation reaches conducting elements (such as the dynodes and the collector/anode) it modulates the flow of electrons through them. For a fixed resistance, these modulations are converted to voltage modulations. The jumps across the border are random in size and time, so this produces random, uncorrelated electromagnetic radiation.

Disclosed herein are various embodiments of an electron multiplier designed to reduce exposure of particularly the electron collector and/or a conductive element (such as a wire) carrying electrons away from the electron collector, and any dynode present. The collector and/or an associated conduit is/are particularly susceptible to voltage fluctuations arising within connected Zener diodes and/or electromagnetic radiation emitted by them, and especially radiation within the radio frequency band. These voltage fluctuations and the radiation at those frequencies increases the noise floor of the electron multiplier output, and accordingly some signal may be lost (i.e. not detected).

In light of the findings above, means for reducing the exposure of the electron collector and/or a conductive element and/or any dynode to deleterious voltage fluctuations and/or electromagnetic radiation are provided.

In some embodiments of the invention, the voltage fluctuations are diminished at the source, i.e. at the voltage stabilizing component or system. For example, a component or system which filters out deleterious frequencies may be provided. In one embodiment, the voltage stabilizing component or system is one or more Zener diodes and in which case a multipole filter may be connected across each of the one or more Zener diodes. The multi-pole filter provides a path for higher frequency components of the voltage fluctuations (higher relative to the strip current) to reach ground. In that regard, substantial amounts of voltage fluctuation are contained and channeled to an electrical ground, and never travel toward a dynode, collector or collector conduit. An exemplary arrangement of a multi-pole filter connected across a 47V Zener diode between the last dynode and the collector/anode, uses two 22 nF capacitors rated for 200V and a 47 kOhm resistor. The two capacitors are connected in parallel. The 47 kOhm resistor is connected in series with one of the two capacitors to shift its frequency response.

The voltage fluctuations that occur within a Zener diode are so completely random that they contain a very broad range of frequencies. The amplitude of the fluctuations decreases with the frequency. Together, the frequencies produce ‘pink’ noise, which is distinguished from ‘white’ noise (which has equal amplitude at all frequencies).

In some embodiments, exposure of a dynode, collector or collector conduit to Zener noise is reduced by the use of an electromagnetic radiation interceptor disposed external to the voltage stabilizing component or system that is capable of interfering in some manner with the transmission of electromagnetic radiation to a dynode, collector or collector conduit. Thus, the radiation may be absorbed and/or reflected and/or deflected and/or diverted and/or bent and/or cancelled and/or diffracted and/or refracted and/or dissipated so as to at least reduce the amount of electromagnetic radiation impinging on a dynode, collector or collector conduit.

With regard to determining the electromagnetic radiation to be intercepted, consideration may be had to the physical structures in the electron multiplier, which typically range from about 0.1 mm to tens of centimetres. If these structures are considered as a quarter-wavelength or half-wavelength antennae, then the ideal wave equation informs that the frequencies are expected to be in the range of: 4×299,792,458/(0.01×1E9)=120 GHz. Frequency increases to a 1 THz value for 1 mm and down to 10 GHz for 10 cm.

In some embodiments of the invention some electromagnetic radiation is diminished at the source and additionally some electromagnetic radiation intercepted outside the source and/or some of the voltage fluctuations are diverted. With regard to voltage fluctuations, Applicant has demonstrated empirically that the use of a 2-level multi-pole filter across each of 3 Zener diodes in combination with an RF shield disposed between the diodes and the collector reduced noise at 100V, 100V and 50V to at most that of a single 50V Zener diode. The 3 Zener diodes were found to improve multiplier linearity, however the expected loss of sensitivity, dynamic range and quantification accuracy caused by noise was not noted.

It could be expected the incorporation of 3 Zener diodes would decrease operational life of the multiplier, with the skilled artisans therefore not even considering such an approach as useful. However, the present inventors appreciated that for certain users an extended operational life is not of primary concern. Of greater concern to some electron multiplier users is a higher level of linearity, although at the same time such users will not accept any substantial decrease in sensitivity, dynamic range and quantification accuracy. The present invention provides for the first time an electron multiplier product fulfilling the technical requirements of such users.

In the present art of electron multipliers, the term “linearity” may refer to one of two aspects of multiplier performance. The first use is with regard to DC linearity, which may refer to the ratio of the actual and expected electron multiplier output for a given ‘gain’, as a function of output current. In this context, for a perfectly linear response, where the electron multiplier input increases 10-fold, then the output should also increase 10-fold. The second use of the term linearity relates to pulse linearity, being a measure of an electron multiplier's ability to respond to the arrival of N simultaneous ions for a given gain. It may be measured in the same manner as DC linearity. The difference being that DC linearity is the linearity measured over an indefinite period of operation, while pulse linearity is measured as an instantaneous response. The two types of linearity are functionally interconnected.

DC linearity and pulse linearity are primarily a function of voltage collapse and capacitance, respectively. The present invention is concerned with DC linearity, and the effect of voltage collapse on DC linearity. Nevertheless, improvements in DC linearity by addressing voltage collapse by way of a voltage stabilisation component or system may indirectly improve pulse linearity to some extent, as will be readily appreciated by a skilled artisan.

By the present invention, linearity is improved by the addition of a voltage stabilizing component or system. In an exemplary form of the invention, the voltage stabilizing component is a Zener diode or a function equivalent thereof. In this context, Zener diodes function by locking the voltage between two points in a circuit thereby limiting or preventing the voltage collapse that contributes to a non-linear response in a multiplier. As is understood in the art Zener diodes deviate from idealised behaviour. For example the reverse break down voltage (Vz) varies somewhat according to the applied current. However, in the context of the present invention variation is negligible, and for practical purposes the Vz of a Zener diodes may be considered as current independent. Multiple Zener diodes may be used in order to provide for better linearity, and preferably at least 3, 4, 5, 6, 7, 8, 9 or 10 are incorporated into the electron multiplier.

The voltage stabilizing component or system is typically introduced into the electron multiplier circuit to address voltage collapse at dynode(s) or dynode region(s) having significant levels of electron flux. This is typically in the terminal at least 1, 2, 3, 4, 5, 6, 7, 8, 9 or 10 dynodes in a discrete dynode multiplier. For a continuous dynode multiplier, the voltage stabilizing component or system is typically introduced to address voltage collapse in the terminal at least 10%, 20%, 30%, 40%, 50%, 60%, 70%, 80% or 90% region of the dynode or dynodes of the multiplier. It is preferred to introduce the voltage stabilizing component or system firstly at the highest electron flux dynodes or dynode regions first (i.e. the terminal dynodes or regions) so as to give the most beneficial effect in terms of linearity. The introduction of a further voltage stabilizing component or system may be instigated where the required level of linearity is not achieved. For example, in a discrete dynode electron multiplier having 12 dynodes, a Zener diode (with a noise filter) may be added to each of the two terminal dynodes (i.e. dynodes 11 and 12). Upon assessing linearity, it may be decided that further improvement is required in which case a Zener diode (with noise filter) may be added to the dynode immediately preceding the 11^{th} dynode (i.e. dynode 10). If yet further improvement is required then another Zener diode (with filter) may be added to the 9th dynode, and so on. Preferably, the overall voltage stabilisation provides a linearity of greater than about 50 μA, 60 μA, 70 μA, 80 μA, 90 μA, or 100 μA.

A cost of adding Zener diodes is that the electron multiplier operating life is shortened. This occurs because locking the voltage between two areas prevents the voltage from being increased to compensate for the aging of the electron multiplier's electron emissive surfaces. Theoretically, virtually infinite linearity could be achieved at the cost of virtually all the electron multiplier life. A technical balance is therefore struck according to the needs of the intended end user.

Zener diode noise was not a material problem in the prior art for three reasons. Firstly, typically only one Zener diode was used thereby limiting the amount of Zener noise sources introduced into the multiplier. Second, the Zener diode was typically placed between the location of the last amplification event (e.g. last dynode in a discrete dynode electron multiplier) and the collector/anode. This is typically only a low voltage (˜50V). Lower Zener diode voltages produce less noise than higher Zener diode voltages. Third, Zener diodes are not typically used on their own to improve electron multiplier linearity. If the resistance of the electron multiplier is reduced, then the same operating voltage will produce a larger ‘strip current’ through the electron multiplier. This in turn delays the onset of voltage collapse. Within the thermal and mechanical limits of the electron multiplier (i.e. melting components), the strip current can be increased without any material effect on performance or service life. Electron multipliers therefore typically combine reduced resistance with the addition of a Zener diode to increase linearity. An unintended side-effect of this approach is that the noise generated by a Zener in the form of voltage fluctuations originates from random, instantaneous charge movement across the P-N barrier. These charge movements can be considered as current fluctuations, which are relatively small for a given voltage that has a larger strip current.

For a desired 100 μA linearity, it may be necessary to use at least 3, 4, or 5 Zener diodes. In circumstances where the electron multiplier is powered by a low power power supply, it is not possible to significantly reduce the multiplier's resistance to increase strip current and delay voltage collapse. Instead, higher voltage Zener diodes (for example about 100v) may be used. An electron multiplier designed in this manner presents a challenging scenario with respect to the mitigating factors described above given the multiple Zener diode noise sources, which diodes are driven at high voltage to produce significant noise without the ability to compensate with a high strip current.

The present invention may (but not necessarily) provide one or more advantages over prior art electron multipliers. For example, greater voltage stabilisation (and therefore greater linearity, and in turn linearity) may be provided while maintaining the same (or lower) electronic noise level (and therefore sensitivity) as compared with prior art multipliers. The additional linearity may translate to a greater dynamic range of the electron multiplier. A mass spectrometer comprising an electronic multiplier of the present invention may use the greater dynamic range to achieve greater throughput. The lower noise floor may also indirectly improve a mass spectrometer throughput by increasing the S/N ratio of acquired data.

Linearity can be increased using voltage stabilisation means (such as by 3, 4 or 5 Zener diodes for example) without reducing the resistance across the electron multiplier. This allows for the use of low power power supplies to power high linearity electron multipliers. In the prior art, high linearity electron multipliers use a lower total resistance to increase the strip current. While this reduces the impact of Zener noise, a high power power supply is required, because power is the mathematical product of voltage and current.

Some implementations of digitisers and Analog-to-Digital Converters (ADCs) in electron multipliers provide a greater response to low frequency components and/or a weaker response to high frequency components in input signals. Delta-Sigma ADCs are an example of the latter. One of their advantages is that they ‘mix’ noise up into high frequencies to which they are insensitive, that in turn increasing S/N ratio and therefore bit depth. Systems such as Delta-Sigma ADCs are particularly sensitive to Zener diode noise but can benefit from the use of multiple Zener diodes when used with means for limiting exposure of the dynodes, electron collector and/or conduit from voltage fluctuations within and/or electromagnetic radiation emitted from the diodes.

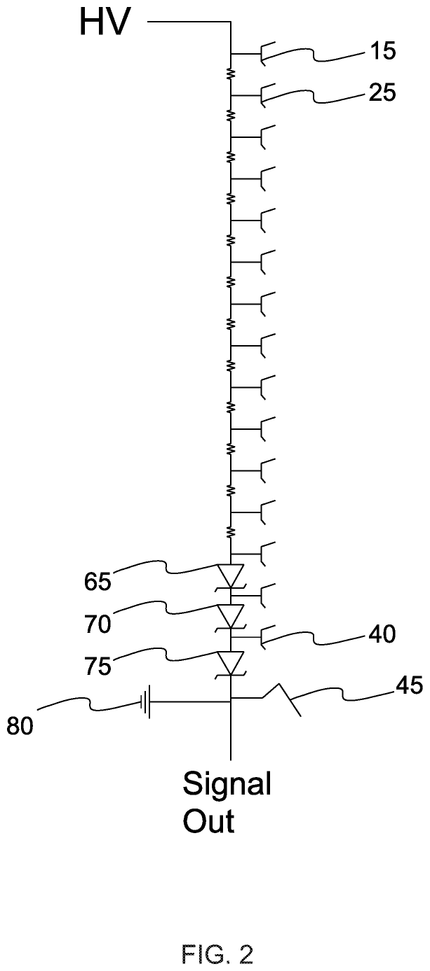

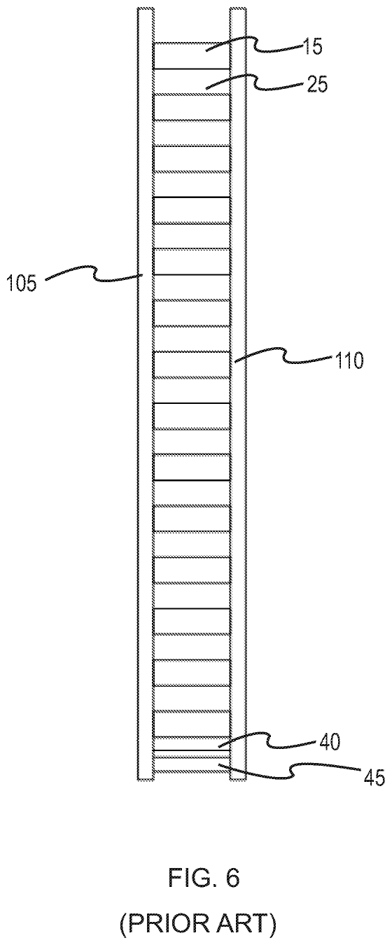

To more fully describe the invention, reference is made to the non-limiting embodiments presented at FIGS. 2, 3, 4, 5, 7, 8 and 9 herein. FIGS. 2 and 6 are provided for comparative purposes.

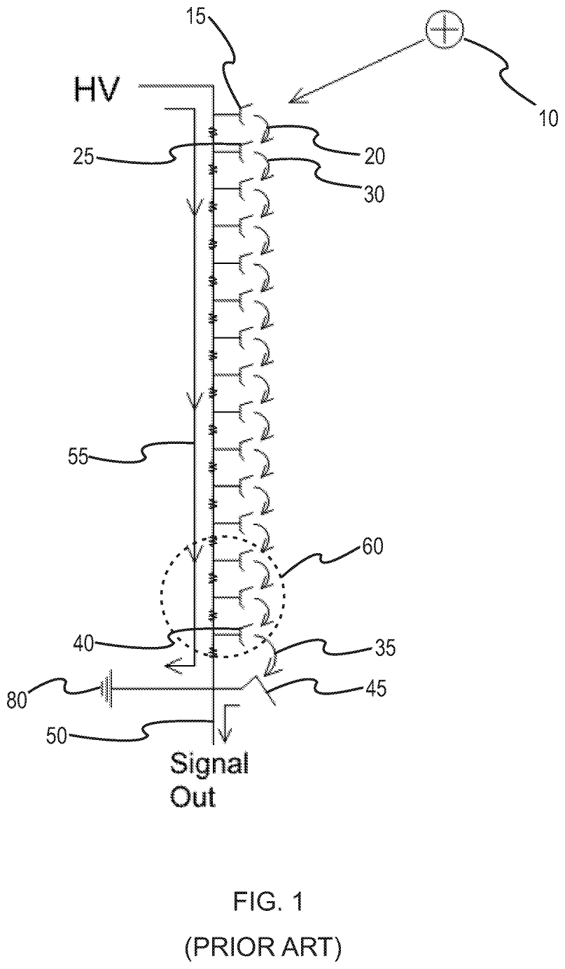

Turning firstly to FIG. 1, a representation of the electrical circuit of a prior art electron multiplier is shown. In operation, an input ion (10) exists an instrument such as a mass spectrometer (not drawn) and impacts the first dynode (15) of the multiplier causing emission of secondary electrons (20). Those secondary electrons subsequently impact the second dynode (25) to release secondary electrons (30) which in turn impact the third dynode, as so on. The number of electrons increases geometrically for each dynode, leading to an avalanche of secondary electrons (35) being emitted by the final dynode (40). Electrons emitted by the final dynode (40) are collected by a collector (45), and form the output signal which is conducted to an analyser (not drawn) by the conduit (50).

The multiplier strip current charge carriers runs along the multiplier as shown by the arrow (55). The significant number of secondary electrons flowing through the terminal region (60) of the multiplier draws on the strip current in the region (60) leading to the propensity for voltage collapse in the terminal region (50). As explained elsewhere herein, voltage collapse has a negative effect on multiplier linearity. The terminal region (60) is shown to comprise three dynodes, although any number of dynodes may be included given that each dynode in the multiplier is capable of drawing strip current and contributing to voltage collapse.

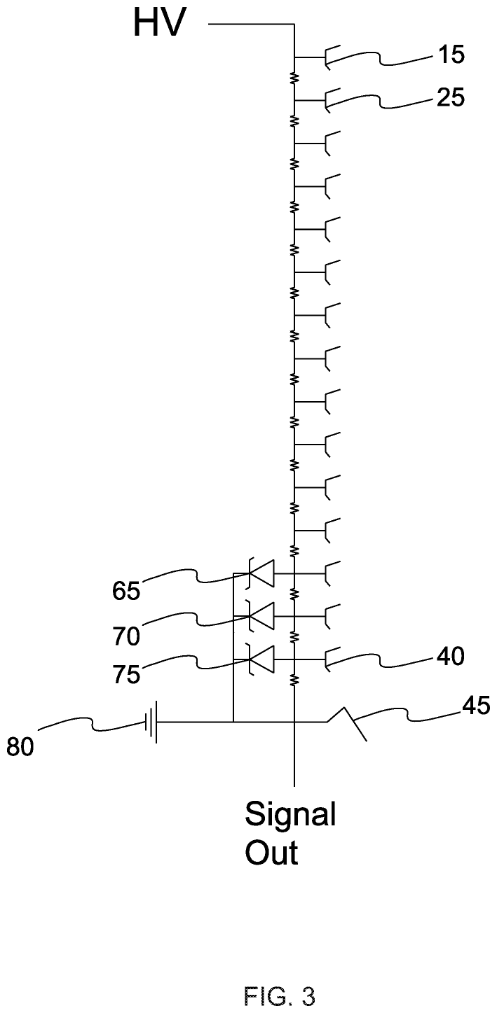

FIG. 2 shows the use of three Zener diodes (65, 70, 75) connected in series with the final three dynodes, and replacing the resistors shown in FIG. 1 for those dynodes. A similar arrangement is shown in FIG. 3, except that the Zener diodes (65, 70, 75) are connected in parallel to the proximal resistors with respect to ground (80). In both cases, the Zener diodes (65, 70, 75) function to lock the voltage of the final 3 dynodes so as to prevent voltage collapse and therefore maintain reasonable linearity of the multiplier. Applicant found that the multipliers of FIG. 2 and FIG. 3 displayed useful linearity (improved over versions having 1 or 2 Zener dynodes) however found that the lower limit of detection suffered. It was found that voltage fluctuations within and/or electromagnetic radiation emitted by the Zener diodes (65, 70, 75) caused degradation of the output signal, which in turn raised the noise floor of the multiplier.

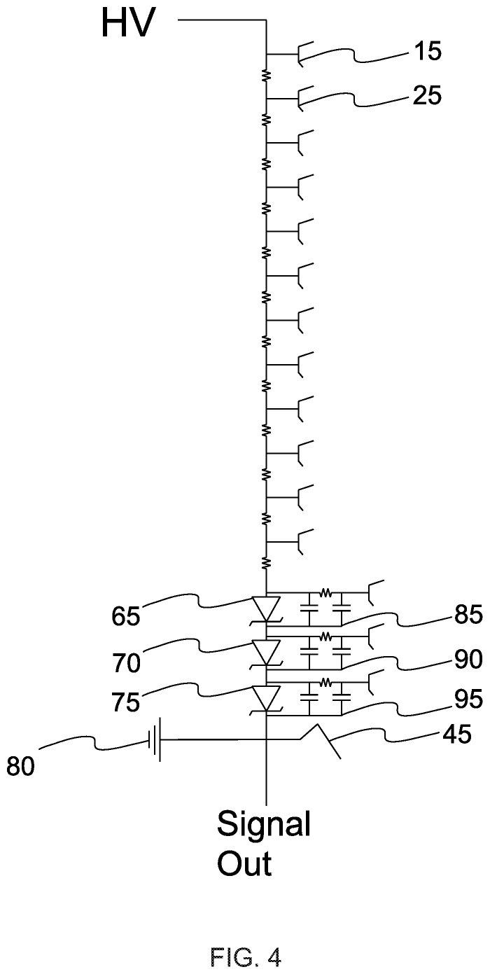

FIG. 4 shows the embodiment of FIG. 2, although with multipole filters (being in this embodiment paired capacitors and a resistor 85, 90, 95) connected in parallel across each of the Zener diodes (65, 70, 75)

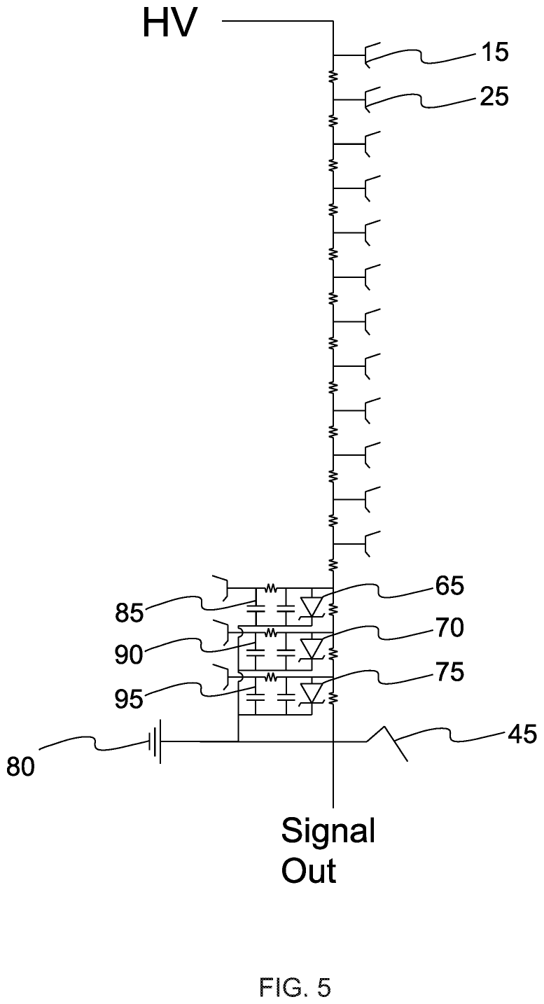

FIG. 5 shows the embodiment of FIG. 3, although with multipole filters (being in this embodiment paired capacitors and a resistor 85, 90, 95) connected in parallel across each of the Zener diodes (65, 70, 75).

In the embodiments of FIG. 4 and FIG. 5 it was found that linearity was improved due to the presence of 3 Zener diodes (65, 70, 75), and degradation of the multiplier output was lessened by the use of the capacitors (85, 90, 95). The filter function of the capacitors (85, 90, 95) operated by shunting noise from the Zener diodes (65, 70, 75), to ground (40) thereby reducing exposure of the collector (45). The limit of detection for incoming ions was found to be unacceptable for some applications.

To further improve performance, RF shielding (as an exemplary electromagnetic radiation interceptor) was incorporated into the structure of the electron multiplier or provided in the form of a new structure. The function of the RF shielding being to reduce exposure of the collector (45) to electromagnetic radiation emitted from the Zener diodes (65, 70, 75).

Turning to FIG. 6, there is shown diagrammatically the gross structure of a prior art discrete dynode electron multiplier. The multiplier comprises a series of discrete dynodes (three of which are marked 15, 25, 40) and an electron collector (45) supported by a first board (105) and a second board (110). Boards (105) and (110) are typically fabricated from a ceramic material. Electrical components (not drawn) are typically mounted on one or both of boards (105) (110).

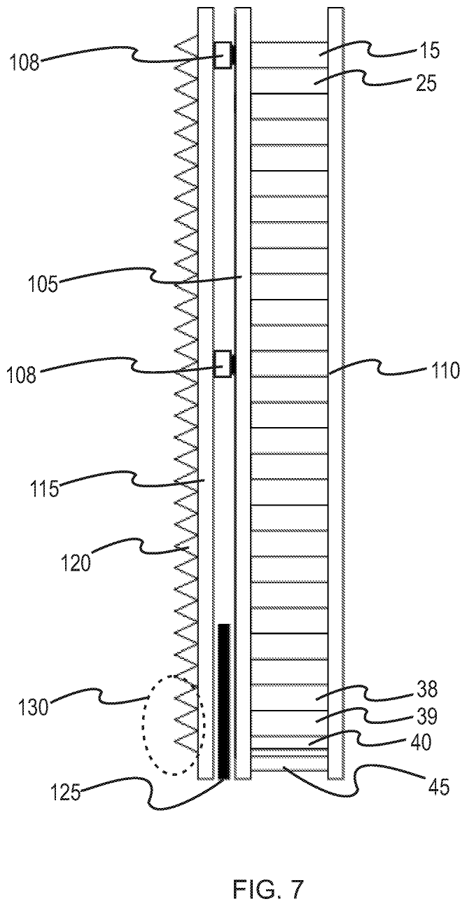

FIG. 7 shows an electron multiplier of the present invention having the gross structure essentially that of FIG. 6, although with a third board (115) having electrical components (120) mounted thereon. In this embodiment, the third board (115) includes all electronic componentry required for operation of the electron multiplier. The third board is attached to the first board (105) by mounting members (108). It will be obvious to one skilled in the art that the electrical components (120) could be mounted on the inner surface of the third board (115) after modifying the mounting members (108).

The circuitry for the embodiment of FIG. 7 is as shown in FIG. 4, with the Zener diodes (65, 70, 75) being mounted on the third board in the region (130), being adjacent to the three terminal dynodes (38, 39, 40) to which the diodes are electrically connected.

An RF shield (125) is disposed between the first board (105) and the third board (115), extending for a length and positioned such that noise emitted by the Zener diodes (65, 70, 75) in the region (130) is inhibited or prevented from impinging on the collector (45).

Where dynodes disposed higher (as drawn) than dynode (38) are connected to Zener diodes, the RF shield (125) is extended higher (as drawn) so as to effectively shield the collector (45) from noise emitted by those higher (as drawn) dynodes. In some embodiments, the RF shield (125) extends upwardly (as drawn) to align with the upper (as drawn) edges of boards (105) and (115), and in which case the mounting members (108) may not be required.

A single ‘board’ in a discrete dynode multiplier may be constructed from multiple layers such as plywood core, an intermediate layer being comprised of a RF shielding material, and an outer layer of an industry standard material.

In some embodiments, a single board in a discrete dynode multiplier may have a cavity formed into it, with an RF shield being disposed within the cavity.

Those skilled in the art will appreciate that the invention described herein is susceptible to further variations and modifications other than those specifically described. It is understood that the invention comprises all such variations and modifications which fall within the spirit and scope of the present invention.

While the invention has been disclosed in connection with the preferred embodiments shown and described in detail, various modifications and improvements thereon will become readily apparent to those skilled in the art. For example, while the present invention is described predominantly by reference to a discrete dynode electron multiplier, the skilled person will readily understand the principles are applicable to other types of multiplier including CEM, multi-channel CEM, MCP, cross-field (magneTOF™), Ceramax and dual mode electron multipliers.

Accordingly, the spirit and scope of the present invention is not to be limited by the foregoing examples, but is to be understood in the broadest sense allowable by law.

1. An electron multiplier comprising a voltage stabilizing component or system, the electron multiplier configured so as to reduce a negative effect of voltage fluctuations within and/or electromagnetic radiation emitted by the voltage stabilizing component or system during operation on an output signal of the electron multiplier.

2. The electron multiplier of claim 1 configured so as to provide the output signal, and further configured so as to decouple the voltage fluctuations within and/or the electromagnetic radiation emitted by the voltage stabilizing component or system from the output signal.

3. The electron multiplier of claim 1 comprising an electron emissive surface and an electron collector configured to collect electrons from the electron emissive surface, wherein the electron multiplier is configured to reduce exposure of a dynode and/or the electron collector and/or a conductive element carrying electrons away from the electron collector to the voltage fluctuations within and/or electromagnetic radiation emitted by the voltage stabilizing component or system.

4. The electron multiplier of claim 3 comprising means for directing voltage fluctuations within the voltage stabilizing component or system away from the dynode and/or the electron collector and/or the conductive element carrying electrons away from the electron collector.

5. The electron multiplier of claim 4, wherein the means for directing voltage fluctuations is configured to direct the voltage fluctuations to an electrical ground.

6. The electron multiplier of claim 4, wherein the means for directing voltage fluctuations is a frequency-specific filter configured to direct a portion of, most of, or substantially all of the voltage fluctuations within the voltage stabilizing component or system away from the dynode and/or the electron collector and/or the conductive element carrying electrons away from the electron collector.

7. The electron multiplier of claim 6, wherein the frequency-specific filter is configured to operate on the voltage fluctuations at frequencies of the voltage fluctuations arising in the voltage stabilizing component or system.

8. The electron multiplier of claim 7, wherein a portion of, most of, or substantially all of the frequencies are higher than significant frequencies of a strip current in a conductor of the electron multiplier.

9. The electron multiplier of claim 7, wherein the frequency-specific filter is configured to filter voltage fluctuations components in a frequency band of 100 Hz to 1000 GHz.

10. The electron multiplier of claim 6, wherein the frequency-specific filter is a multipole filter connected to the voltage stabilizing component or system.

11. The electron multiplier of claim 3, comprising an electromagnetic radiation interceptor configured and positioned to reduce an amount of electromagnetic radiation emitted by the voltage stabilizing component or system to which the dynode and/or the electron collector and/or the conductive element carrying electrons away from the electron collector is/are exposed.

12. The electron multiplier of claim 11, wherein the electromagnetic radiation interceptor is configured to absorb and/or reflect and/or deflect, and/or divert and/or bend and/or cancel and/or diffract and/or refract and/or dissipate electromagnetic radiation emitted by the voltage stabilizing component or system.

13. The electron multiplier of claim 11, wherein the electromagnetic radiation interceptor is fabricated from an electrically conductive and/or a magnetic material.

14. The electron multiplier of claim 11, wherein the electromagnetic radiation interceptor is continuous or discontinuous, including a mesh.

15. The electron multiplier of claim 11, wherein the electromagnetic radiation interceptor is configured to absorb and/or reflect and/or deflect, and/or divert and/or bend and/or cancel and/or diffract and/or refract and/or dissipate some, most, or substantially all of the electromagnetic radiation emitted by the voltage stabilizing component or system.

16. The electron multiplier of claim 11, wherein the electromagnetic radiation interceptor is a radio frequency (RF) shield.

17. The electron multiplier of claim 11, wherein the electromagnetic radiation interceptor or part thereof is physically disposed along a line of sight between the voltage stabilizing component or system and the dynode and/or the electron collector and/or the conductive element carrying electrons away from the electron collector.

18. The electron multiplier of claim 11, wherein the electromagnetic radiation interceptor partially or substantially completely surrounds the voltage stabilizing component or system.

19. The electron multiplier of claim 11, wherein the electromagnetic radiation interceptor contacts or is adjacent to a structure of the electron multiplier.

20. The electron multiplier of claim 19, wherein the structure is a board of the electron multiplier.

21. The electron multiplier of claim 20, wherein the board provides a substrate for one or more electrical or electronic components of the electron multiplier.

22. The electron multiplier of claim 11, wherein the electromagnetic radiation interceptor is configured to absorb and/or reflect and/or diffract and/or refract electromagnetic radiation in a frequency band of 0.1 GHz to 1000 GHz.

23. The electron multiplier of claim 1, wherein the voltage stabilizing component or system is a current limiting component or system.

24. The electron multiplier of claim 23, wherein the current limiting component or system is or comprises a diode.

25. The electron multiplier of claim 24, wherein the diode is a voltage sensitive diode.

26. The electron multiplier of claim 1, wherein the voltage stabilizing component is a Zener diode, an avalanche diode or a functional equivalent thereof.

27. The electron multiplier of claim 1, wherein the voltage stabilizing component or system comprises at least one Zener diode, avalanche diode or a functional equivalent thereof.

28. The electron multiplier of claim 1, wherein the voltage stabilizing component or system comprises at least 1, 2, 3, 4 or 5 Zener diodes or avalanche dynodes, or functional equivalents thereof.

29. The electron multiplier of claim 1, wherein the electromagnetic radiation emitted by the voltage stabilizing component or system is flicker noise or pink noise.

30.-31. (canceled)

32. A scientific instrument having installed therein the electron multiplier of claim 1.
